(19) United States
(12) Patent Application Publication
(10) Pub. No.: US 2010/0253689 A1
(43) Pub. Date: Oct. 7, 2010

(54) PROVIDING DESCRIPTIONS OF NON-VERBAL COMMUNICATIONS TO VIDEO TELEPHONY PARTICIPANTS WHO ARE NOT VIDEO-ENABLED

(75) Inventors: Brian K. Dinicola, Monroe Township, NJ (US); Paul Roller Michaelis, Louisville, CO (US)

Correspondence Address: SHERIDAN ROSS P.C., 1560 BROADWAY, SUITE 1200, DENVER, CO, 80202, US

(73) Assignee: AVAYA INC., Basking Ridge, NJ (US)

(21) Appl. No.: 12/419,705

(22) Filed: Apr. 7, 2009

(51) Int. Cl. G06T 11/00; G06K 9/46

(52) U.S. Cl. 345/467; 382/190; 382/100

(57) ABSTRACT

The use of detected non-verbal communications cues, and summaries thereof, are used to provide audible, textual and/or graphical input to listeners who for any reason do not have the benefit of being able to see the non-verbal communications cues, or speakers about mannerisms or other non-verbal signals they are sending to other parties. This includes cues that are given while speaking or listening. The detection of one or more of an emotion and gesture could also trigger a dynamic behavior. For example, certain emotions and gestures could be characterized as “key emotions” or “key gestures” and a particular action associated with the detection of one of these “key emotions” or “key gestures.”

### FIELD OF THE INVENTION

One exemplary aspect of the present invention is directed toward non-verbal communications. More specifically, one exemplary aspect is directed toward providing information about non-verbal communication in audio form to either a speaker or a listener such that they can benefit from awareness of the non-verbal communications.

### BACKGROUND OF THE INVENTION

Non-verbal communication (NVC) is usually understood as the process of communicating through sending and receiving wordless messages. Such messages can be communicated through gesture, body language or posture, facial expressions and eye contact, the presence or absence of nervous habits, object communication, such as clothing, hair styles, or even architecture, symbols and info-graphics. Speech may also contain non-verbal elements known as para-language, including voice quality, emotion and speaking style, as well as prosodic features such as rhythm, intonation and stress. Likewise, written texts have non-verbal elements such as handwriting style, spatial arrangement of words, or the use of emoticons. However, much of the study of non-verbal communication has focused on face-to-face interaction, where it can be classified into three principle areas: environmental conditions where communication takes place, the physical characteristics of the communicators, and behaviors of communicators during interaction.

Non-verbal communication in many cases can convey more information than verbal communications. When participants in a discussion cannot benefit from these non-verbal communication cues, they are disadvantaged with regard to perceiving the entire (verbal and non-verbal) message. Such cases where the participant may not benefit from non-verbal communication cues include, but are not limited to, when they are visually impaired, when they are located in another place and are participating via voice only and/or where the user is mobile and either can't view video because of laws in that regard (such as viewing video while driving) or because their device will not support video.

### SUMMARY OF THE INVENTION

One aspect of the present invention provides a method for communicating via alternate (audible, textual and/or graphic) means for descriptions of such non-verbal communications. Such alternative non-verbal communications can be sent about any speaker or listener to any other party on that communication session and can communicate cues while talking or listening.

Another aspect of the present invention is directed toward providing feedback to a presenter or speaker about non-verbal cues that they are exhibiting that they may want to be aware of. Examples of this include, but are not limited to, someone displaying emotion; blindisms (behaviors that a person blind since birth may have that are annoying to others), constant gaze or staring that could be viewed as negative, and the like.

Real-time communications do not currently convey any non-verbal information unless one can see the party who is communicating. Reasons behind this include limitations in gesture or other non-verbal detection technology, latency with regard to delivery because of processing time and use of succinct summaries of non-verbal communications.

In accordance with another exemplary embodiment, the use of detected non-verbal communications cues, and summaries thereof, are used to provide audible, textual and/or graphical input to:
1. Listeners who for any reason do not have the benefit of being able to see the non-verbal communications cues, or
2. Speakers about mannerisms or other non-verbal signals they are sending to other parties.

This includes cues that are given while speaking or listening. For example, you have party A as a principle speaker and B, C as listeners. Assuming that all three parties are voice only, this method could send party A's cues to B and C for case 1 above, party B's cues to A and C (case 1 again), and party C's cues to A and B (case 1 again). Similarly, the feedback to a speaker or responder could, for case 2 above, be for any and all parties on the communication session.

One method of supplying this summary of non-verbal communications would be a so-called whisper announcement to either the listener or speaker. Another exemplary method would be to supply a graphical indication such as an emoticon. Still another method would be a textual summary. Each of these exemplary methods has advantages in certain situations and disadvantages in others. One aspect of the system allows customization such that the system is capable of providing whichever form is most suitable to the target device and/or the user.

Integration of the non-verbal input could similarly be done with consideration of the target device and the user. Examples could include using emoticons when the user has the ability to look at their device but does not have the ability via a headset to hear a whisper announcement. For users who are blind, tactilely discernible emoticons could be presented by a refreshable Braille display.

Associated with one exemplary embodiment of the present invention could be a preference file that indicates in what form a user desires non-verbal communications in as a function of time, place, device, equipment or personal capabilities, or the like. Similarly, a speaker or presenter who desires feedback about non-verbal cues that they are sending could also have a preference about how such information is provided to them. For example, supplying an emoticon or key word could be less disruptive to a speaker or presenter than a whisper announcement.

While certain aspects of gesture recognition is known, another exemplary aspect of the present invention is directed toward leveraging the recognition of gestures, and in particular key gestures, and performing some action based thereupon. For example, an automatic process could look at and analyze gestures of one or more of the conference participants and/or a speaker. As discussed hereinafter, a correlation could be made between the verbal communication and the gestures which could then be recorded in, for example, transcript form. Once the gestures have been recognized, a summary of the gestures could be sent via one or more of a text channel, whisper channel, non-video channel, SMS message, or the like and provided via one or more emoticons. The recognition of gestures can even be dynamic such that upon the recognition of a certain gesture, a particular action commences. Furthermore, gesture recognition could be used for self-analysis, group analysis, and as feedback into the gesture recognition model to further improve gesture recognition capabilities.

Gesture recognition, and the providing of the descriptions thereof of the non-verbal communications to other participants need not be user centric, but could also be based on one or more individuals within a group, such as a video conference, one or more users associated with a web cam, or the like.

In accordance with yet another exemplary embodiment, the detection, monitoring and analysis of one or more of gestures and emotions could be used, for example, to assist with teaching in remote classrooms. For example, gestures such as the raising of a hand to indicate a user's desire to ask a question could be recognized, and in a similar manner, a user, such as a teacher, could be provided an indicator that based on an analysis of one or more of the students, it appears the students are beginning to get sleepy. For example, this analysis could be triggered by the detection of one or more yawns by students in the classroom.

As discussed, the detection of one or more of an emotion and gesture could also trigger a dynamic behavior. For example, certain emotions and gestures could be characterized as “key emotions” or “key gestures” and a particular action associated with the detection of one of these “key emotions” or “key gestures.” For example, in continuing the above scenario, if a student raises their hand to ask a question, this could be recognized as a key gesture and the corresponding action be panning and zooming of a video camera to focus on the user asking the question, as well as redirection of a parabolic microphone to ensure the user's question can be heard.

In addition to being able to provide dynamic behavior, the recognition of one or more emotions and gestures can be used to provide a more comprehensive transcript of, for example, a video conference. For example, the transcript could include traditional information, such as what was spoken at the conference, as well as supplemented with one or more of emotion and gesture information as recognized by an exemplary embodiment of the present invention.

In accordance with yet another exemplary embodiment, there can be a plurality of participants who are not video-enabled and desire to receive an indicator of non-verbal communications. Thus, one or more of the participants who are not video-enabled, can have an associated profile that allows for one or more of the selection and filtering of what types of emotions and/or gestures the user will receive. In addition, the profile can specify how information relating to the descriptions of the non-verbal communications should be presented to that user. As discussed, this information could be presented via a text channel, via a whisper, such as a whisper in channel A while the conference continues on channel B, and/or a non-video channel associated with the conference, and/or in an SMS message, or MSRP messaging service that allows, for example, emoticons. This profile could be user-centric, endpoint-centric or associated with a conferencing system. For example, if the user is associated with either a bandwidth or processor limited-endpoint, it may be more efficient to have the profile associated with the conference system. Alternatively, or in addition, and for example, at the endpoint associated with a user is a laptop and associated webcam, one or more aspects of the profile (and functionality associated therewith) could be housed on the laptop.

Accordingly, one exemplary aspect of the invention is directed toward providing non-verbal communication descriptors to non-video enabled participants.

Still another aspect of the present invention is directed toward providing descriptions of non-verbal communications to video telephony participants who are not video-enabled.

Even further aspects of the invention are directed toward the detection and monitoring of emotions in a video conferencing environment.

Still further aspects of the invention are directed toward the recognition, analysis and communication of one or more gestures in a video conferencing environment.

Even further aspects of the invention are directed toward a gesture reaction upon the determination of the gesture being a key gesture.

Even further aspects of the invention are directed toward creating, managing and correlating certain gestures to certain actions.

Even further aspects of the invention are directed toward a user profile that specifies one or more of the types of information to be received and the communication modality for that information.

Aspects of the invention also relate to generation and production of a transcript associated with a video conference that includes one or more of emotion and gesture information. This emotion and gesture information can be associated with one or more of the conference participants.

Yet another aspect of the present invention provides a video conference participant, such as the moderator or speaker, feedback as to the types of emotions and/or gestures present during their presentation.

Even further aspects of the invention relate to assessing the capabilities of one or more of the conference participants and, for each participant that is not video-enabled, associating therewith messaging preferences based, for example, on their capabilities and/or preferences.

Even further aspects of the invention relate to analyzing and recognizing a series of gestures for which one description can be provided.

Even further aspects of the invention relate to recognizing the various types of audio and/or video inputs associated with one or more users in a conference and utilizing this information to further refine one or more actions that may or may not be taken upon the recognition of a key gesture.

For ease of discussion, the invention will generally be described in relation to gesture recognition and analysis. It should however be appreciated that one or more of gestures and emotions can be recognized and analyzed as well as a determination made as to whether or not they are key, and performing an action associated therewith.

Still further aspects of the invention relate to providing an ability to adjust the granularity of a conference transcript to thereby govern what type of emotions and/or gestures should be included therein. For example, some gestures, such as a sneeze, could be selected to be ignored while on the other hand, an individual shaking their head or smiling may be desired to be captured.

Aspects of the invention may also prove useful during interrogations, interviews, depositions, court hearings, or in general any environment in which it may be desirable to include one or more of gesture and emotion information in a recorded transcript.

Even further aspects of the invention relate to the ability to provide one or more conference participants with an indication as to which gestures may trigger a corresponding action. For example, and again in relation to the classroom environment, students could be given information that the raising of a hand will cause the conference camera to zoom in and focus on them, such that they may ask a question. This allows, for example, one or more of the users to positively control a conference through the use of deliberate gestures.

Therefore, for example in a conference room where a number of users are facing the camera with no access to any of the video conference functionality control buttons, one way to send a command to the conference system could be through the use of key gestures. This dynamic conference control through the use of gestures has broad applicability in a number of environments and can be used whether one person is at a conference endpoint, or a plurality of individuals. For example, using hand-based signaling, a user could request that a video camera zoom in on them and, upon completion of their point, provide another hand-based signal that returns the camera to viewing of the entire audience.

As discussed, one exemplary aspect of the invention provides audible and/or text input to conference participants who are unable to see one or more of emotions and gestures that one or more other conference participants may be making. Examples of how this information could be provided include:
1. For conference participants who have a single monaural audio-only endpoint, audio descriptions of the emotions and/or gestures could be presented via a “whisper” announcement.
2. For conference participants who have more than one monaural audio-only endpoint, they could use one of the endpoints for listening to the conference discussion then utilize the other to receive audio descriptions of the emotions and/or gestures. In addition, they could receive an indication as to whether a key gesture was recognized, and the corresponding action being performed.
3. Conference participants who have a binaural audio-only endpoint could use one of the channels for listening to the conference discussions, and utilize the other to receive audio descriptions of one or more of the detected emotions, gestures, key gestures or the like.
4. Conference participants who have an audio endpoint that is email capable, SMS capable, or IM capable could receive descriptions via these respective interfaces.
5. Conference participants who have an audio endpoint that is capable of receiving and displaying streaming text (illustratively, a SIP endpoint that supports IETF recommendation RFC-4103, “RTP payload for text conversation”) can have the description scroll across the endpoint's display, such that the text presentation is synchronized with the spoken information on the conference bridge.

The present invention can provide a number of advantages depending on the particular configuration. These and other advantages will be apparent from the disclosure of the invention(s) contained herein.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic even if performance of the process or operation uses human input, whether material or immaterial, received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like.

While circuit or packet-switched types of communications can be used with the present invention, the concepts and techniques disclosed herein are applicable to other protocols.

Accordingly, the invention is considered to include a tangible storage medium or distribution medium and prior art-recognized equivalents and successor media, in which the software implementations of the present invention are stored.

The terms “determine,” “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the invention is described in terms of exemplary embodiments, it should be appreciated that individual aspects of the invention can be separately claimed.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

### BRIEF DESCRIPTION OF THE DRAWINGS

FIG. 1 illustrates an exemplary communications environment according to this invention;

FIGS. 2-3 illustrate exemplary conference transcripts according to this invention; and

FIG. 4 outlines an exemplary method for providing descriptions of non-verbal communications to conference participants who are not vide-enabled according to this invention.

### DETAILED DESCRIPTION

The invention will be described below in relation to a communications environment. Although well suited for use with circuit-switched or packet-switched networks, the invention is not limited to use with any particular type of communications system or configuration of system elements and those skilled in the art will recognize that the disclosed techniques may be used in any application in which it is desirable to provide secure feature access. For example, the systems and methods disclosed herein will also work well with SIP-based communications systems and endpoints. Moreover, the various endpoints described herein can be any communications device such as a telephone, speakerphone, cellular phone, SIP-enabled endpoint, softphone, PDA, conference system, video conference system, wired or wireless communication device, or in general any communications device that is capable of sending and/or receiving voice and/or data communications.

The exemplary systems and methods of this invention will also be described in relation to software, modules, and associated hardware and network(s). In order to avoid unnecessarily obscuring the present invention, the following description admits well-known structures, components and devices that may be shown in block diagram form, are well known, or are otherwise summarized.

For purposes of explanation, numerous details are set forth in order to provide a thorough understanding of the present invention. It should be appreciated however, that the present invention may be practiced in a variety of ways beyond the specific details set forth herein.

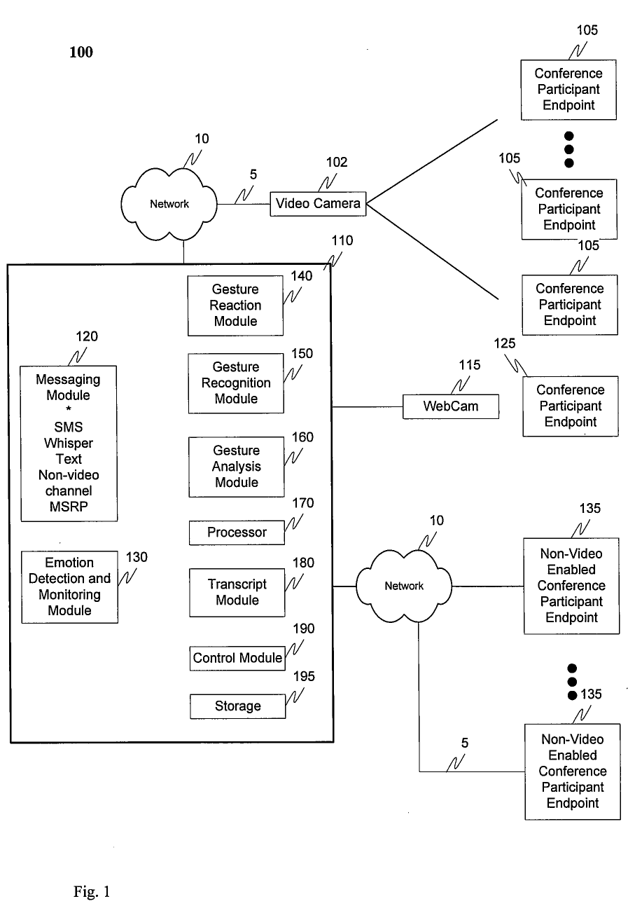

FIG. 1 illustrates an exemplary communications environment 100 according to this invention. In accordance with this exemplary embodiment, the communication environment is for video conferencing between a plurality of endpoints. More specifically, communications environment 100 includes a conferencing module 110, and one or more networks 10, and associated links 5, connected to a video camera 102 viewing one or more conference participant endpoints 105. The communication environment 100 also includes a web cam 115, associated with conference participant endpoint 125, and one or more non-video enabled conference participant endpoints 135, connected via one or more networks 10 and links 5, to the conference module 110.

The conference module 110 includes a messaging module 120, an emotion detection and monitoring module 130, a gesture reaction module 140, a gesture recognition module 150, a gesture analysis module 160, processor 170, transcript module 180, control module 190 and storage 195, as well as other standard conference bridge componentry which will not be illustrated for sake of clarity.

In operation, a video conference is established with the cooperation of the conference module 110. For example, video camera 102, which may have associated audio inputs and presentation equipment, such as a display and loudspeaker, could be associated with conference participants 105. Webcam 115 is provided for conference participant 125 with audio and video therefrom being distributed to the other conference endpoints. The non-video enabled conference participants 135 either because of endpoint capabilities or user impairment are not able to receive or view video content. The capabilities of these various endpoints can be registered with the conference module 110, and in particular the messaging module 120, upon initiation of the video conference. Alternatively, the messaging module 120 can interrogate one or more of the endpoints and determine its capabilities. In addition, one or more of each endpoint and/or a user associated with each endpoint may have a profile that not only specifies the capabilities of the endpoint but also messaging preferences. As discussed, these messaging preferences can include the types of information to be received as well as how that information should be presented. As discussed hereinafter in greater detail, the messaging module 120 forwards this information via one or more of the requested modalities to one or more of the conference endpoints. It should be appreciated that while the messaging module 120 will in general only send the description information to non-video enabled conference participants, this messaging could in general be sent to any conference participant.

Transcript module 180, in cooperation with one or more of the processer 170 and storage 195 can be enacted upon the commencement of the video conference to create a conference transcript that includes one or more of the following pieces of information: participant information, emotion information, gesture information, key gesture information, reaction information, timing information, and in general any information associated with the video conference and/or one of the described modules. The conference transcript can be conference participant centric or, a “master” conference transcript that is capable of capturing and memorializing any one or more aspects of the video conference.

Upon commencement of the video conference, one or more of the video-enabled participants are monitored and one or more of their emotions and gestures recognized. In cooperation with the emotion detection monitoring module 130 and gesture recognition module 150, once one or more of an emotion and gesture are recognized, a determination is made whether that is a reportable gesture. If it is a reportable gesture, and in cooperation with the transcript module 180, that emotion or gesture is recorded in one or more of the appropriate transcripts. In addition, the gesture analysis module 160 analyzes the recognized gesture to determine if it is a key gesture. If the gesture is a key gesture, and in cooperation with the gesture reaction module 140, the corresponding action associated with that key gesture is taken. The storage 195 can store, for example, a table that draws a correlation between a key gesture and a corresponding reaction. Once the correlation between a key gesture and a corresponding reaction is made, the gesture reaction module 140 cooperates with the control module 190 to perform that action. As discussed, this action can in general be any action capable of being performed by any one or more of the components in the communications environment 100 and even more generally, any action associated with a video conferencing environment.

The determination by the gesture recognition module 150 as to whether a gesture is reportable can be based on one or more of a “master” profile as well as individual profiles associated with one or more conference participants. A profile could also be associated with a group of conference participants for which common reporting action is desired. Thus, the gesture recognition module 150 is capable of parallel operation ensuring the transcript module 180 receives all necessary information to ensure all desired reportable events are being recorded and/or forwarded to one or more endpoint(s).

Typical gesture information includes the raising of a hand, shaking of the head, nodding and the like, and more in generally can include any activity being performed by a monitored conference participant. Emotions are generally items such as whether a conference participant is nervous, blushing, smiling, crying, or in general any emotion a conference participant may be expressing. While the above has been described in relation to a gesture reaction module it should be appreciated that comparable functionality can be provided based on the detection of one or more emotions. Similarly, it should be appreciated that it could be a singular emotion or gesture that triggers a corresponding reaction, or a combination of one or more emotions and/or gestures that triggers a corresponding reaction(s).

Examples of reactions include one or more of panning, tilting, zooming, increasing microphone volume, decreasing microphone volume, increasing loud speaker volume, decreasing loud speaker volume, switching camera feeds, and in general any conference functionality.

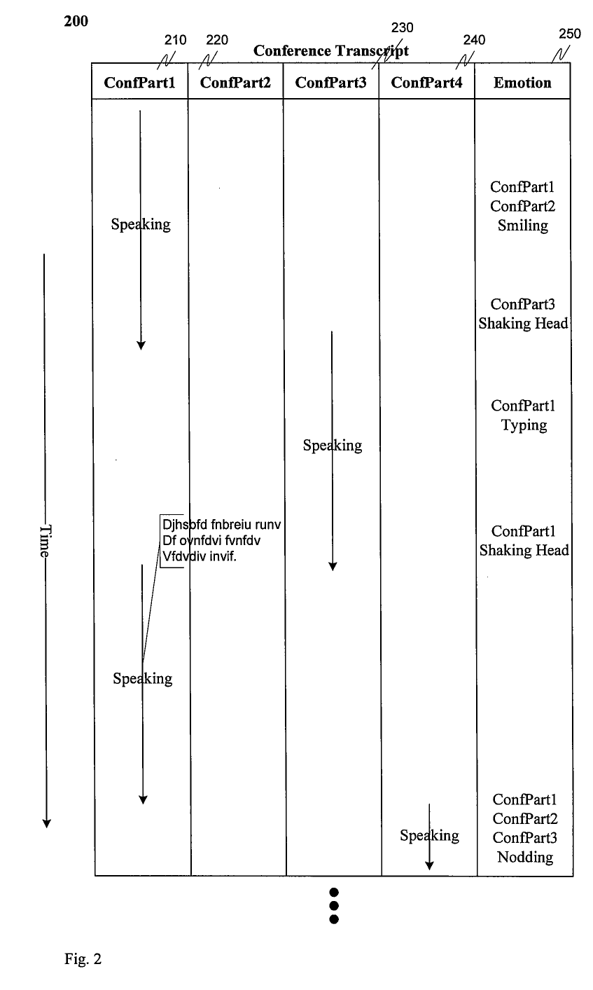

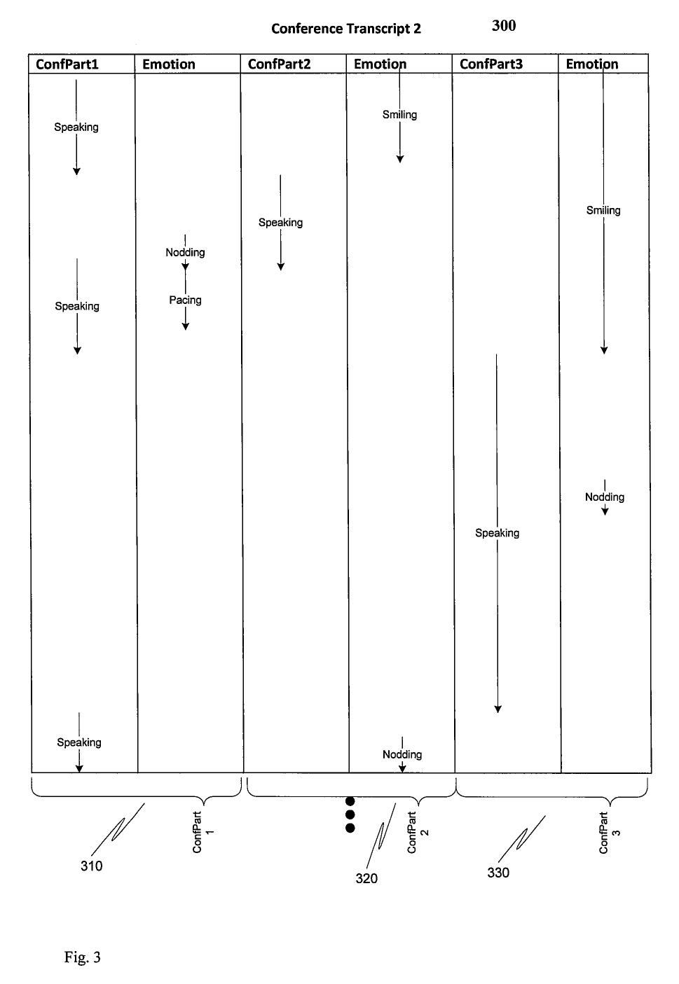

FIGS. 2-3 illustrate exemplary conference transcripts according to an exemplary embodiment of this invention. In conference transcript 200, illustrated in FIG. 2, four illustrative conference participants (210, 220, 230 and 240) are participating and, as each participant speaks, their speech recognized, for example, with the use of a speech-to-text converter and logged in the transcript. In addition, there is an emotion section 250 that summarizes one or more of the various emotions and gestures recognized as time proceeds through the video conference. The emotion section 250 can be participant-centric, and can also include motion and/or gesture information for a plurality of participants that may coincidently be performing the same gesture or experiencing the same emotion. Even more generally, any action taken by a conference participant could also be summarized in this emotion portion 250, such as conference participant 1 typing during conference participant 3 speaking. As mentioned above, this conference transcript 200 and in a similar manner conference transcript 300, can be customized based on, for example, a particular conference participant's profile. This conference transcript could be presented in real-time for one or more of the conference participants and stored either in storage 195, at an endpoint and/or forwarded to, for example, a destination specified in the profile at the conclusion of the conference, e.g. email.

FIG. 3 illustrates an optional embodiment of a conference transcript 300. In this particular embodiment, the emotion and/or gesture information is located adjacent to the corresponding conference participant. This could be useful to assist with focusing more particularly on a particular conference participant. In addition, one or more of the conference transcript 200 and conference transcript 300 could be dynamic and, for example, selectable such that a user could return to the conference transcript after conference has finished and replay either a recoded portion of the conference and/or the particular footage associated with a recorded emotion and/or gesture. Even though not illustrated, one or more of the conference transcripts 200 and 300 could also include a reaction column that provides an indication as to which one or more reactions were performed during the conference.

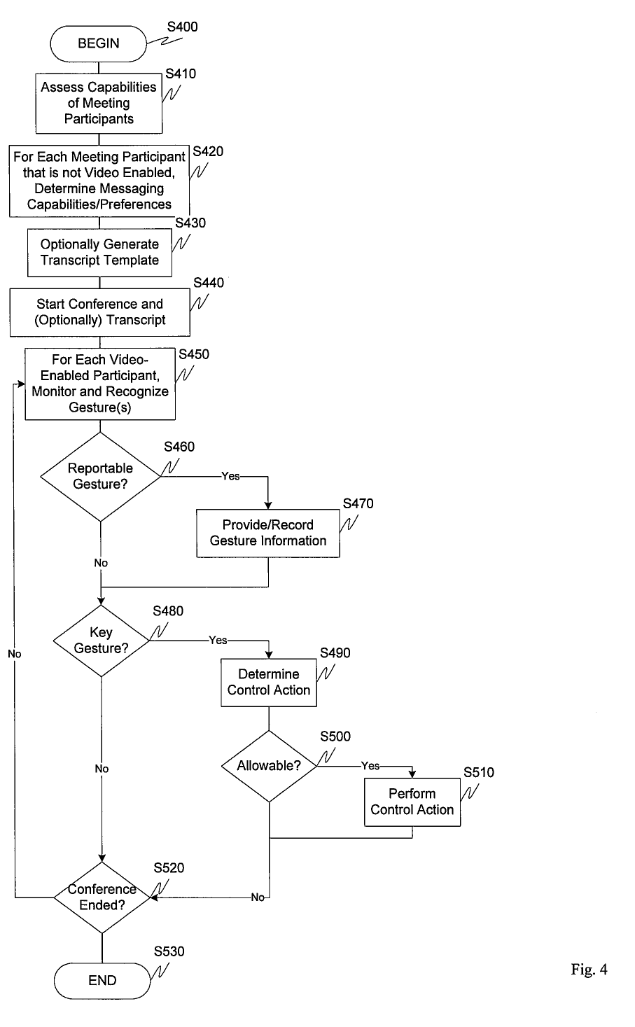

FIG. 4 illustrates an exemplary method of operation of providing descriptions of non-verbal communications to video telephony participants who are not video-enabled. While FIG. 4 will generally be directed toward gestures, it should be appreciated that corresponding functionality could be applied to emotions and/or a series of emotions and gestures that, when combined, are a triggering event. In particular, control begins at step S400 and continues to step S410. In step S410, the system can optionally assess the capabilities of one or more of the meeting participants. Next, in step S420, and for each meeting participant that is not video-enabled, the messaging preferences and/or capabilities of one or more of the meeting participants can be determined. Then, in step S430, a transcript template can be generated that includes, for example, portions for one or more of the conference participants, emotions, gestures, and reaction portions. Control then continues to step S440.

In step S440, the conference commences and transcripting optionally started. Next, in step S450, and for each video-enabled participant, their gestures are monitored and recognized. Then, in step S460, a determination is made whether the gesture is a reportable gesture. If the gesture is reportable, control continues to step S470 where gesture information corresponding to a description of the gesture is one or more of provided and recorded to one or more appropriate endpoints. Control then continues to step S480.

In step S480, a determination is made whether a gesture, or a sequence of gestures, is a key gesture. If it is a key gesture, control continues to step S490 with control otherwise jumping to step S520.

In step S490, a control action(s) associated with the gesture is determined. Next, in step S500, a determination is made whether the control action(s) is allowable. For example, this determination could be made based on one or more of the capabilities of one or more endpoints, information associated with a profile governing whether gestures from that particular endpoint will be recognized, and a particulars specific key gesture, or the like. If the action(s) is allowable, control continues to step S510 where the action is performed. As discussed, this action could also be logged in a transcript. Control then continues back to step S520.

In step S520, a determination is made whether the conference has ended. If the conference has not ended, control jumps back to step S450 where further gestures are monitored. Otherwise, transcripting, if initiated, is concluded with control jumping to step S530 where the control sequence ends.

A number of variations and modifications of the invention can be used. It would be possible to provide or claims for some features of the invention without providing or claiming others.

The exemplary systems and methods of this invention have been described in relation to enhancing video conferencing. However, to avoid unnecessarily obscuring the present invention, the description omits a number of known structures and devices. This omission is not to be construed as a limitation of the scope of the claimed invention. Specific details are set forth to provide an understanding of the present invention. It should however be appreciated that the present invention may be practiced in a variety of ways beyond the specific detail set forth herein.

Furthermore, while the exemplary embodiments illustrated herein show various components of the system collocated, certain components of the system can be located remotely, at distant portions of a distributed network, such as a LAN, cable network, and/or the Internet, or within a dedicated system. Thus, it should be appreciated, that the components of the system can be combined in to one or more devices, such as a gateway, or collocated on a particular node of a distributed network, such as an analog and/or digital communications network, a packet-switch network, a circuit-switched network or a cable network.

It will be appreciated from the preceding description, and for reasons of computational efficiency, that the components of the system can be arranged at any location within a distributed network of components without affecting the operation of the system. For example, the various components can be located in a switch such as a PBX and media server, gateway, a cable provider, enterprise system, in one or more communications devices, at one or more users' premises, or some combination thereof. Similarly, one or more functional portions of the system could be distributed between a communications device(s) and an associated computing device.

Furthermore, it should be appreciated that the various links, such as link 5, connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

In yet another embodiment, the systems and methods of this invention can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention.

Exemplary hardware that can be used for the present invention includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A method for providing non-verbal communications to non-video enabled video conference participants comprising:
recognizing one or more of a gesture and an emotion;
determining information describing the one or more of the gesture and the emotion; and
forwarding, based on preference information, the information to one or more destinations, wherein the one or more destinations are video conference endpoints.

2. The method of claim 1, wherein the one or more destinations are non-video enabled conference endpoints.

3. The method of claim 1, further comprising determining if one or more gestures are a key gesture.

4. The method of claim 3, further comprising performing one or more actions based on the key gesture.

5. The method of claim 1, further comprising determining if one or more emotions are a key gesture.

6. The method of claim 5, further comprising performing one or more actions based on the key gesture.

7. The method of claim 1, further comprising generating a transcript including the information.

8. The method of claim 1, where the information is one or more of text, an emoticon, a message, an audio description and a graphic.

9. The method of claim 1, further comprising associating a profile with a video conference, the profile specifying one or more types of the one or more of a gesture and an emotion that are to be described and the modality for providing the description.

10. The method of claim 1, further comprising:
for conference participants who have a single monaural audio-only endpoint, providing the information as audio descriptions via a “whisper” announcement;
for conference participants who have more than one monaural audio-only endpoint, using one of the endpoints for listening to a conference and utilizing the other endpoint to receive audio descriptions of the information;
for conference participants who have a binaural audio-only endpoint, using one of the channels for listening to conference discussions, and utilizing the other endpoint to receive audio descriptions of the information;
for conference participants who have an audio endpoint that is email capable, SMS capable, or IM capable, sending the information via one or more of these respective interfaces; and
for conference participants who have an audio endpoint that is capable of receiving and displaying streaming text, scrolling the information across an endpoint's display.

11. A computer-readable storage media having stored thereon instructions that, when executed, perform the steps of claim 1.

12. One or more means for performing the steps of claim 1.

13. A system that provides non-verbal communications to non-video enabled video conference participants comprising:
a gesture recognition module that recognizes one or more of a gesture and an emotion;
a messaging module that determines information describing the one or more of the gesture and the emotion and forwards, based on preference information, the information to one or more destinations, wherein the one or more destinations are video conference endpoints.

14. The system of claim 13, wherein the one or more destinations are non-video enabled conference endpoints.

15. The system of claim 13, further comprising a gesture reaction module that determines if one or more gestures are a key gesture and performs one or more actions based on the key gesture.

16. The system of claim 13, further comprising a gesture reaction module that determines if one or more emotions are a key gesture and performs one or more actions based on the key gesture.

17. The system of claim 13, further comprising a transcript module that generates a transcript including the information.

18. The system of claim 13, where the information is one or more of text, an emoticon, a message, an audio description and a graphic.

19. The system of claim 13, further comprising a profile, the profile associated with a video conference, the profile specifying one or more types of the one or more of a gesture and an emotion that are to be described and the modality for providing the description.

20. The system of claim 13, wherein:
for conference participants who have a single monaural audio-only endpoint, providing the information as audio descriptions via a “whisper” announcement;
for conference participants who have more than one monaural audio-only endpoint, using one of the endpoints for listening to a conference and utilizing the other endpoint to receive audio descriptions of the information;
for conference participants who have a binaural audio-only endpoint, using one of the channels for listening to conference discussions, and utilizing the other endpoint to receive audio descriptions of the information;
for conference participants who have an audio endpoint that is email capable, SMS capable, or IM capable, sending the information via one or more of these respective interfaces; and
for conference participants who have an audio endpoint that is capable of receiving and displaying streaming text, scrolling the information across an endpoint's display.
